(19) United States
(12) Patent Application Publication
(10) Pub. No.: US 2023/0408460 A1
(43) Pub. Date: Dec. 21, 2023

(54) SAMPLE SUPPLY DEVICE AND GAS CHROMATOGRAPH

(71) Applicant: Shimadzu Corporation, Kyoto-shi (JP)

(72) Inventors: Yoshitake YAMAMOTO, Kyoto-shi (JP); Akira AONO, Kyoto-shi (JP)

(21) Appl. No.: 18/139,109

(22) Filed: Apr. 25, 2023

(30) Foreign Application Priority Data
Jun. 15, 2022 (JP) 2022-096393

(51) Int. Cl. G01N 30/32; B01D 53/02

(52) U.S. Cl. CPC G01N 30/32; B01D 53/025; G01N 2030/025

(57) ABSTRACT

Provided is a sample container and a gas chromatograph capable of detecting the pressure in the flow path for supplying a pressurized gas into a flow path. The ample supply device includes and insertion tube, a pressurized gas supply unit, a valve, and a pressure sensor. The pressurized gas supply unit is connected to the insertion tube via the flow path. The valve opens and closes the flow path. The pressure sensor senses the pressure between the valve and the insertion tube in the flow path. In the sample supply device, the pressure in the flow path connecting the pressurized gas supply unit and the insertion tube is detected, based on the detection signal from the pressure sensor in a state in which the valve is closed, and the insertion tube is inserted into the space in the sample container, before supplying a pressurized gas by a pressurized gas supply unit.

### CROSS-REFERENCE TO RELATED APPLICATIONS

This application claims priority under 35 U.S.C. § 119 to Japanese Patent Application No. 2022-096393 filed on Jun. 15, 2022, the entire disclosure of which is incorporated herein by reference in its entirety.

### BACKGROUND OF THE INVENTION

### Field of the Invention

The present invention relates to a sample supply device and a gas chromatograph for supplying a sample gas.

### Description of the Related Art

For example, in a sample introduction device as disclosed in the below-listed Patent Document 1, a sample in a sample container having a space called a headspace formed above is heated, whereby a gas (sample gas) containing the components of the volatilized sample is stored in the headspace. When collecting the sample gas in a sample loop, a needle (insertion tube) is inserted into the sample container, and a pressurized gas is supplied to the headspace in the sample container via the needle. As a result, the inner side of the headspace is pressurized, so that the sample gas can be led out to the sample loop by the pressure in the headspace.

### PRIOR ART DOCUMENTS

Patent Document
Patent Document 1: International Publication WO 2014/038019

### Problems to be Solved by the Invention

In such a headspace sample introduction device, a valve is provided in the flow path connecting the pressurized gas supply port and the needle. When the headspace is pressurized with pressurized gas, the valve is switched from the closed state to the open state after the needle is inserted into the headspace in the sample container.

However, when the pressure of the sample gas in the headspace is high, when the needle is inserted into the headspace, the pressure in the flow path connecting the supply port of the pressurized gas and the needle, specifically in the flow path between the valve in a closed state and the needle becomes higher. In a case where the pressure in this flow path is higher than the pressure of the pressurized gas, when the valve is opened, there is a possibility that the sample gas flows backward through the flow path. Therefore, in such a case, a portion of the flow path not contaminated by the sample gas may be contaminated by the sample gas.

### SUMMARY OF THE INVENTION

The present invention has been made in view of the above circumstances, and an object of the present invention is to provide a sample container and a gas chromatograph capable of detecting a pressure in a flow path for supplying a pressurized gas into a sample supply device before supplying the pressurized gas into the sample container.

### Means for Solving the Problems

According to a first aspect of the present invention, a sample supply device for supplying a sample gas generated in a space in a sample container by volatilizing the sample in the sample container to a supply destination, includes:

an insertion tube configured to be inserted into the space in the sample container;

a pressurized gas supply unit connected to the insertion tube via a flow path to supply a pressurized gas for pressurizing the space to the space via the flow path and the insertion tube;

a valve configured to open and close the flow path;

a pressure sensor configured to detect a pressure between the valve and the insertion tube in the flow path; and

a controller to which a detection signal is input from the pressure sensor,

wherein the controller includes:

a pressurizing unit configured to pressurize the space by supplying the pressurized gas into the space from the pressurized gas supplying unit via the flow path and the insertion tube by opening the valve in a state in which the insertion tube is inserted into the space;

a sample derivation processing unit configured to derive the sample gas in the space by a pressure in the space before processing by the pressurization processing unit;

a pressure detection processing unit configured to detect a pressure in the flow path based on the detection signal from the pressure sensor in a state in which the valve is closed and the insertion tube is inserted into the space before processing by the pressurization processing unit; and

a signal generation processing unit configured to generate a signal based on a detection result by the pressure detection processing unit.

According to a second aspect of the present invention, a gas chromatograph includes:

the sample supply device; and

a column as a supply destination of a sample gas supplied from the sample supply device.

### Effects of the Invention

According to the first aspect of the present invention, it is possible to detect the pressure in the flow path for providing the pressurized gas into the sample container, before providing the pressurized gas to the inside of the sample container.

According to the second aspect of the present invention, it is possible to supply the sample gas to the column by using the sample supply device capable of detecting the pressure in the flow path for supplying the pressurized gas into the sample container before supplying the pressurized gas into the sample container.

### BRIEF DESCRIPTION OF THE DRAWINGS

The preferred embodiments of the present invention are shown by way of example, and not limitation, in the accompanying figures.

FIG. 1 is a schematic diagram showing an example of the configuration of a gas chromatograph according to an embodiment.

FIG. 2 is a schematic diagram showing an example of the configuration of the sample supply device according to the embodiment.

FIG. 3 is a block diagram showing an example of the electrical configuration of the sample supply device according to the embodiment.

FIG. 4 is a diagram for describing the operation of the sample supply device according to the embodiment.

FIG. 5 is a diagram for describing the operation of the sample supply device according to the embodiment.

FIG. 6 is a diagram for describing the operation of the sample supply device according to this embodiment.

FIG. 7 is a diagram for describing the operation of the sample supply device according to this embodiment.

FIG. 8 is a functional block diagram showing a specific example of the electrical configuration of the sample supply device according to this embodiment.

FIG. 9 is a flowchart showing an example of the operation flow of the sample supply device according to this embodiment.

### DESCRIPTION OF THE PREFERRED EMBODIMENTS

In the following paragraphs, some preferred embodiments of the present invention will be described by way of example and not limitation. It should be understood based on this disclosure that various other modifications can be made by those skilled in the art based on these illustrated embodiments.

### 1. Configuration of Gas Chromatograph

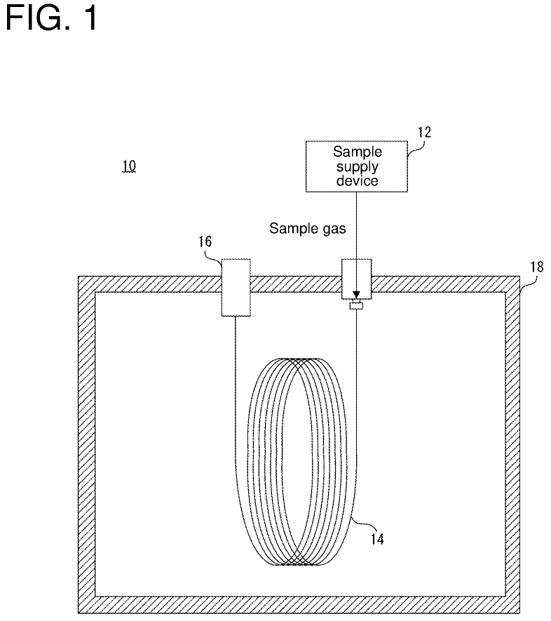

FIG. 1 is a schematic diagram showing one example of the configuration of the gas chromatograph 10 according to this embodiment. The gas chromatograph 10 is provided with a sample supply device 12, a column 14, a detector 16, and the like.

The sample supply device 12 is a device for supplying a sample gas to the supply destination. Note that in the gas chromatograph 10, the supply destination of the sample gas is the column 14.

The column 14 is heated in a column oven 18. The components of the sample gas introduced into the column 14 are separated in the process of passing through the column 14 and detected by the detector 16.

### 2. Configuration of Sample Supply Device

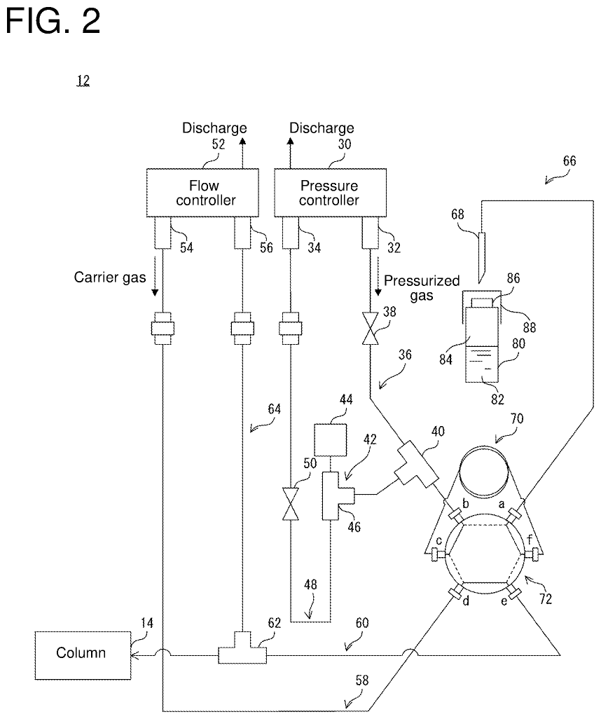

FIG. 2 is a schematic diagram showing one example of the configuration of the sample supply device 12 according to this embodiment. Specifically, the sample supply device 12 according to this embodiment is a device for supplying a sample gas generated in the space 84 in the sample container 80 by the volatilization of the sample 82 in the sample container 80 to the supply destination. The space 84 is a so-called headspace and is formed above the sample 82 in the sample container 80.

The sample supply device 12 is provided with a pressure controller (APC) 30, a pressurized gas supply unit 32, a pressurized gas outlet 34, a first gas flow path 36, a first open/close valve 38, a first branch joint 40, a second gas flow path 42, a pressure sensor 44, a second branch joint 46, a third gas flow path 48, a second open/close valve 50, a flow controller (AFC) 52, a carrier gas supply unit 54, a carrier gas discharge port 56, a fourth gas flow path 58, a fifth gas flow path 60, a third branch joint 62, a sixth gas flow path 64, a seventh gas flow path 66, an insertion tube 68, a sample loop 70, a six-way valve 72, and the like.

The pressure controller 30 is connected to a carrier gas source (not shown), such as, e.g., a gas cylinder, regulates the pressure of the carrier gas to a constant pressure greater than atmospheric pressure, and then provides it as a pressurized gas. Note that the pressurized gas may be set in advance.

The pressure controller 30 is provided with the pressurized gas supply unit 32 and the pressurized gas outlet 34. The pressurized gas supply unit 32 is connected to the first gas flow path 36, the pressurized gas outlet 34 is connected to the third gas flow path 48. To the first gas flow path 36, a pressurized gas with a constant pressure is supplied from the pressurized gas supply unit 32. Further, the pressurized gas in the third gas flow path 48 is discharged via the pressurized gas outlet 34.

The first gas flow path 36 is a flow path with one end connected to the pressurized gas supply unit 32 and the other end connected to a port “b” of the six-way valve 72. Therefore, the pressurized gas supply unit 32 is connected to the port “b” of the six-way valve 72 via the first gas flow path 36.

The first gas flow path 36 is provided with the first open/close valve 38. The first open/close valve 38 is an electrically controllable general-purpose valve, such as, e.g., a solenoid valve.

The first gas flow path 36 is provided with the first branch joint 40. In particular, the first branch joint 40 is provided between the first open/close valve 38 and the six-way valve 72 on the first gas flow path 36.

The first branch joint 40 is a joint for connecting an end portion of another flow path to the flow path. Therefore, the first gas flow path 36 is branched by the first branch joint 40 and connected to the second gas flow path 42.

The second gas flow path 42 is a flow path with one end connected to the first gas flow path 36 and the other end connected to the pressure sensor 44. That is, the pressure sensor 44 is provided at a portion branched from the first gas flow path 36, specifically, at a portion between the first open/close valve 38 of the first gas flow path 36 and the six-way valve 72. As the pressure sensor 44, for example, a piezoelectric device is used. Note that the type of the pressure sensor 44 is not particularly limited as long as it can measure the pressure of a gas.

Further, the second gas flow path 42 is provided with a second branch joint 46 which is similar to the first branch joint 40. Therefore, the second gas flow path 42 is branched by the second branch joint 46 and connected to the third gas flow path 48.

The third gas flow path 48 is a flow path with one end connected to the second gas flow path 42 and the other end connected to the pressurized gas outlet 34. The third gas flow path 48 is provided with a second open/close valve 50 which is similar to that of the first open/close valve 38.

In the same manner as in the pressure controller 30, the flow controller 52 is connected to a carrier gas source (not shown), such as, e.g., a gas cylinder, to provide a carrier gas regulated at a constant flow rate. Further, the flow controller 52 discharges a carrier gas with the flow rate of the split carrier gas at a constant. The flow rate of the carrier gas can be set in advance.

The flow controller 52 is provided with a carrier gas supply unit 54 and a carrier gas discharge port 56. The carrier gas supply unit 54 is connected to the fourth gas flow path 58, and the carrier gas discharge port 56 is connected to the sixth gas flow path 64. To the fourth gas flow path 58, a carrier gas with a constant flow rate is supplied from the carrier gas supply unit 54. Further, the carrier gas in the sixth gas flow path 64 is discharged from the carrier gas discharge port 56.

The pressure controller 30 and the flow controller 52 may be omitted from the sample supply device 12. However, in such a case, a device having the same functions as those of the pressure controller 30 and the flow controller 52 is used separately from the sample supply device 12.

The fourth gas flow path 58 is a flow path with one end connected to the carrier gas supply unit 54 and the other end connected to a port “d” of the six-way valve 72. Therefore, the carrier gas supply unit 54 is connected to the port “d” of the six-way valve 72 via the fourth gas flow path 58.

The fifth gas flow path 60 is a flow path having one end connected to the column 14 and the other end connected to a port “e” of the six-way valve 72. Therefore, the column 14 is connected to the port “e” of the six-way valve 72 via the fifth gas flow path 60.

Further, the fifth gas flow path 60 is provided with a third branch joint 62 which is similar to that of the first branch joint 40. Therefore, the fifth gas flow path 60 is branched by the third branch joint 62 and connected to the sixth gas flow path 64.

The sixth gas flow path 64 has one end connected to the fifth gas flow path 60 and the other end connected to the carrier gas discharge port 56. That is, to the column 14, the remaining gas divided by the sixth gas flow path 64 is supplied.

The seventh gas flow path 66 is a flow path with one end connected to the insertion tube 68 and the other end connected to a port “a” of the six-way valve 72. As such, the insertion tube 68 is connected to the port “a” of the six-way valve 72 via the seventh gas flow path 66. Note that the insertion tube 68 is a needle shaped tube. In other words, the insertion tube 68 also serves as a flow path.

The sample loop 70 is a flow path having a predetermined capacitance, one end of which is connected to a port “c” of the six-way valve 72 and the other end of which is connected to a port “f” of the six-way valve 72.

The six-way valve 72 has a valve element (not shown) having ports “a” to “f” and a plurality of grooves, and the grooves communicate with the adjoining ports “a” to “f.” Further, in the six-way valve 72, the combination of the ports “a” to “f” that communicate with each other can be switched by rotating the valve element.

The six-way valve 72 is switchable between a first state and a second state. When the six-way valve 72 is in a first state, the port “f” and the port “a” are in communication, the port “b” and the port “c” are in communication, and the port “d” and the port “e” are in communication, as indicated by the solid line. When the six-way valve 72 is in a second state, the port “a” and the port “b” are in communication, the port “c” and the port “d” are in communication, and the port “e” and the port “f” are in communication, as shown by the dashed line.

Note that in the six-way valve 72, the switching between the first state and the second state is performed by being electrically controlled, but may be performed manually.

Further, a container 80 can be set to the above-described sample supply device 12. In the sample container 80, a liquid or solid sample 82 is stored in advance. The sample 82 is heated to volatilize. Therefore, the sample gas is generated within the space 84 in the sample container 80.

Further, since the sample container 80 is sealed by a septum 86, the generated sample gas is stored within the space 84 in the sample container 80. The septum 86 is fixed by a cap 88. This allows the inside of the sample container 80 to be pressurized to a pressure greater than atmospheric pressure.

According to the sample supply device 12, the pressurized gas supply unit 32 can be connected to the insertion tube 68 via flow paths including the first gas flow path 36, the sample loop 70, and the seventh gas flow path 66. The insertion tube 68 can be inserted into the space 84 in the sample container 80 as appropriate.

Therefore, the sample supply device 12 is configured such that a pressurized gas is supplied to the space 84 in the sample container 80 via the first gas flow path 36, the sample loop 70, the seventh gas flow path 66, and the insertion tube 68.

However, the sample supply device 12 may be configured such that the pressurized gas is supplied to the space 84 in the sample container 80 without passing through the sample loop 70. If the pressurized gas can be supplied to the space 84, and the sample gas can be supplied to the column 14, for example, a plurality of three-way valves may be used instead of the six-way valve 72.

Note that in the following description, the flow path connecting the pressurized gas supply unit 32 and the insertion tube 68 is simply referred to as a “connection flow path.” The connection flow path includes at least the first gas flow path 36 and the seventh gas flow path 66. In the sample supply device 12 configured as shown in FIG. 2, the connection flow path includes the first gas flow path 36, the sample loop 70, and the seventh gas flow path 66.

For these reasons, the pressurized gas supply unit 32 is connected to the insertion tube 68 via the connection flow path, and the pressurized gas for pressurizing the space 84 in the sample container 80 can be supplied to the space 84 via the connection flow path and the insertion tube 68.

The first open/close valve 38 can open and close the connection flow path. Further, the pressure sensor 44 can detect the pressure between the first open/close valve 38 and the insertion tube 68 in the connection flow path.

Note that the pressure sensor 44 may be provided in the seventh gas flow path 66, for example, as long as the pressure between the first open/close valve 38 and the insertion tube 68 in the connection flow path can be detected.

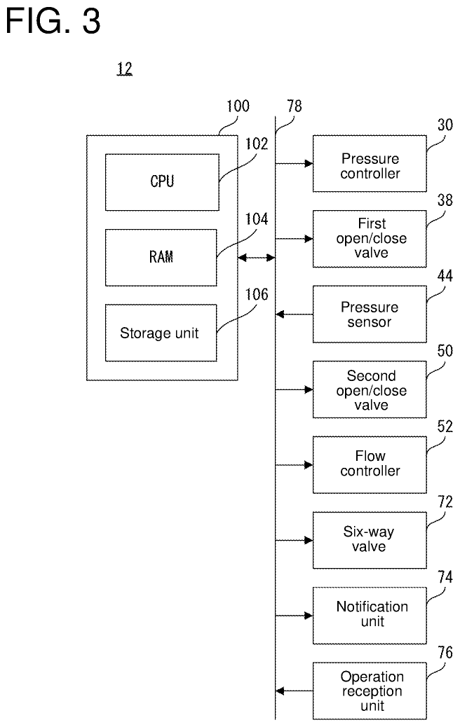

FIG. 3 is a block diagram showing one example of the electrical configuration of the sample supply device 12 according to this embodiment. In addition to the pressure sensor 44, etc., the sample supply device 12 is provided with a notification unit 74, an operation reception unit 76, a device controller 100, and the like.

Further, the device controller 100, the pressure controller 30, the first open/close valve 38, the pressure sensor 44, the second open/close valve 50, the flow controller 52, the six-way valve 72, the notification unit 74, the operation reception unit 76, and the like are electrically connected to each other via a circuit 78, such as, e.g., a bus.

The notification unit 74 is provided to notify a predetermined matter. In the case of performing a visual notification, a light-emitting member, such as, e.g., a display and a lamp, can be used as the notification unit 74. Further, in the case of performing an audible notification, a sound generating member, such as, e.g., a speaker, can be used as the notification unit 74.

The operation reception unit 76 accepts any operations. As the operation reception unit 76, an input device, such as, e.g., a pointing device, a keyboard, a touch panel, and a hardware-type button, can be used.

The device controller 100 is responsible for the general control of the sample supply device 12. The device controller 100 is provided with a CPU (Central Processing Unit) 102. Further, the device controller 100 is provided with a RAM (Random Access Memory) 104 and a storage unit 106 directly accessible by the CPU 102.

The RAM 104 is used as a work area and a buffer area of the CPU 102. A non-volatile memory, such as, e.g., an HDD (Hard Disc Drive) and an SSD (Solid State Drive), is used as the storage unit 106.

The storage unit 106 stores a program (control program) for controlling the operation of the sample supply device 12, data (data for execution) required for executing the control program, and the like. Note that the storage unit 106 may be configured to include the RAM 104.

Although not shown, the sample supply device 12 is provided with a heater or the like for heating the sample 82 in the sample container 80, and is electrically controllable.

Further, the device controller 100 may be omitted from the sample supply device 12. However, in such a case, the operations of the various components related to the sample supply device 12 are controlled by the controller which is responsible for the entire control of the gas chromatograph 10. That is, in this case, the various processing described below is executed by the controller of the gas chromatograph 10.

### 3. Operation of Sample Supply Device

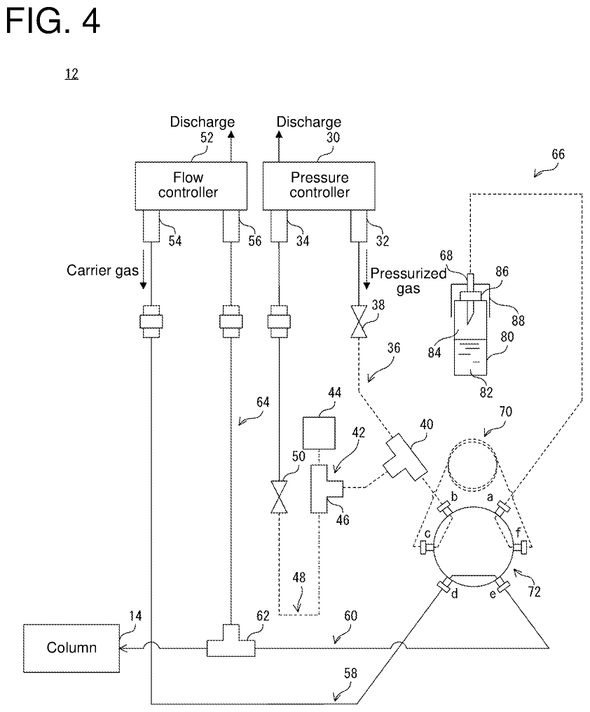

In the sample supply device 12 according to this embodiment, a plurality of processing is sequentially executed when analyzing the sample gas. Hereinafter, the operations of the sample supply device 12 will be described with reference to FIG. 4 to FIG. 7. Note that each of FIG. 4 to FIG. 7 is a diagram for describing the operation of the sample supply device 12 according to this embodiment.

In this embodiment, when analyzing the sample gas, insertion processing is executed first. The insertion processing is processing of inserting the insertion tube 68 into the space 84 in the sample container 80. When the insertion processing is started, the six-way valve 72 is set to the first state, and the first open/close valve 38 and the second open/close valve 50 are closed. Further, when the state transition of the various valves is completed as described above, the insertion tube 68 is inserted into the space 84 in the sample container 80.

Therefore, when the insertion processing is executed, the sample supply device 12 becomes in the state shown in FIG. 4. Note that in FIG. 4, the sealed flow paths are represented by broken lines.

After the insertion processing, the first pressure detection processing is executed with the state shown in FIG. 4. The first pressure detection processing is processing for detecting the pressure in the connection flow path, specifically the pressure between the open/close valve 38 and the insertion tube 68 in the connection flow path, based on the detection signal from the pressure sensor 44, in a state in which the insertion tube 68 is inserted in the space 84.

Further, when the first pressure detection processing is executed, a signal (reference signal) based on the detection result in the first pressure detection processing is generated. In particular, it represents the pressure in the connection flow path.

Following the first pressure detection processing, first determination processing is executed with the state shown in FIG. 4. The first determination processing is processing of determining, based on the reference signal, whether there is a possibility that the sample gas flows backward from the connection flow path to the pressurized gas supply unit 32 when the first open/close valve 38 is opened by pressurization processing described later.

In the first determination processing, the pressure in the connection flow path detected by the first pressure detection processing is compared to a threshold. Specifically, the pressure value at the time when the pressure in the connection flow path detected by the first pressure detection processing is stabilized is compared with the pressure value (the pressure set value of the pressurized gas at the pressure controller 30) of the pressurized gas supplied from the pressurized gas supply unit 32.

Note that the threshold is not limited to the pressure value of the pressurized gas supplied from the pressurized gas supply unit 32 and may be a value obtained by multiplying the pressure value by a coefficient, or may be a value other than the above. When the pressure in the connection flow path is equal to or higher than the threshold, it is determined that there is a possibility that the sample gas flows backward. On the other hand, when the pressure in the connection flow path is less than the threshold, it is determined that there is no possibility that the sample gas flows backward.

When a pressure value of the pressurized gas is used as the threshold, it is possible to assuredly determine whether the sample gas flows backward from the connection flow path to the pressurized gas supply unit 32. For this reason, it is preferable to use the pressure value of the pressurized gas as a threshold. Since the pressure of the pressurized gas is set in advance as described above, the pressure value can be used as the threshold.

In this embodiment, when it is determined that there is a possibility that the sample gas flows backward from the connection flow path to the pressurized gas supply unit 32, the execution of the pressurization processing to be described later is stopped. Further, in this situation, the notification unit 74 may notify the pressurized gas supply unit 32 that there is a possibility that the sample gas flows backward.

Note that when the execution of the pressurization processing is stopped, the execution of the subsequent processing subjected to the pressurized gas is also stopped in the same manner. That is, the executions of the remaining processing among the remaining processing related to supplying the sample gas are stopped.

Further, when it is determined that there is a possibility that the sample gas flows backward from the connection flow path to the pressurized gas supply unit 32, instead of stopping the execution of the pressurization processing which will be described later, the notification unit 74 may notify the pressurized gas supply unit 32 that there is a possibility that the sample gas flows backward. Further, in this case, the operation reception unit 76 or the gas chromatograph 10 may be operated to adjust the pressure of the pressurized gas. For example, when an operation for adjusting the pressure of the pressurized gas is accepted by the operation reception unit 76 and the pressure of the pressurized gas increases, the first pressure detection processing and the first determination processing may be executed again.

In this embodiment, in a case where there is no possibility that the sample gas flows backflows from the connection flow path to the pressurized gas supply unit 32, the pressurization processing is executed.

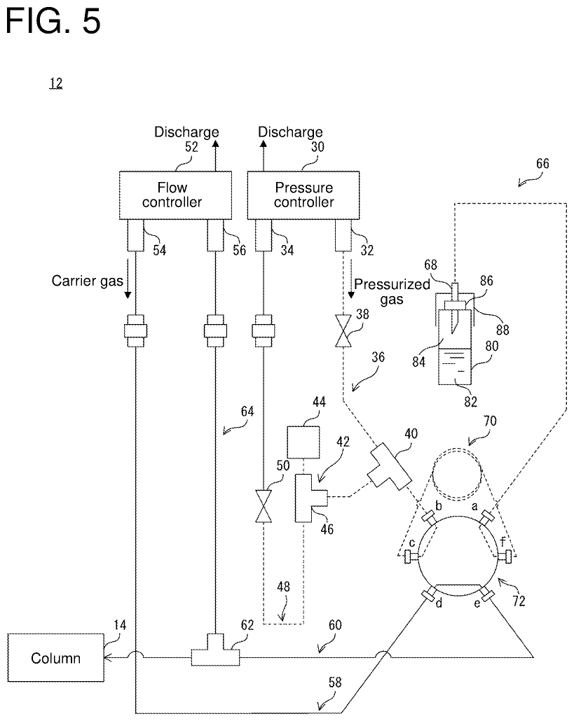

The pressurization processing is processing in which the first open/close valve 38 is opened in a state in which the insertion tube 68 is inserted into the space 84 of the sample container 80 as shown in FIG. 4, the pressurized gas is supplied from the pressurized gas supply unit 32 to the space 84 via the connection flow path and the insertion tube 68. When heating processing is executed, the sample supply device 12 becomes in the state shown in FIG. 5. Note that the flow path through which the pressurized gas flows is represented by the broken line in FIG. 5.

Further, the first open/close valve 38 is closed when a predetermined time has elapsed since it was opened. The pressurization processing is terminated when the first open/close valve 38 is closed. Therefore, when the pressurization processing ends, the sample supply device 12 becomes the state shown in FIG. 4 again.

Following the pressurization processing, the second pressure detection processing is executed in the state shown in FIG. 4. The second pressure detection processing, similar to the first pressure detection processing, is the processing of detecting the pressure in the connection flow path.

Following the second pressure detection processing, the second determination processing is executed in the state shown in FIG. 4. The second determination processing is the processing of determining the presence or absence of a gas leakage. In the second determination processing, the variation of the pressure in the connection flow path detected by the second pressure detection processing is referred. When the pressure in the connection flow path changes in a predetermined time by more than a threshold, it is determined that a gas leakage has occurred. On the other hand, when the pressure in the connection flow path does not change by more than a threshold in a predetermined time, it is determined that no gas leakage has occurred.

In this embodiment, when it is determined that there is no gas leakage, sample derivation processing which will be described later is executed. When it is determined that a gas leakage has occurred, sample derivation processing may be executed after notifying the occurrence of the gas leakage, or the remaining processing among the processing related to the sample gas supplying may be stopped.

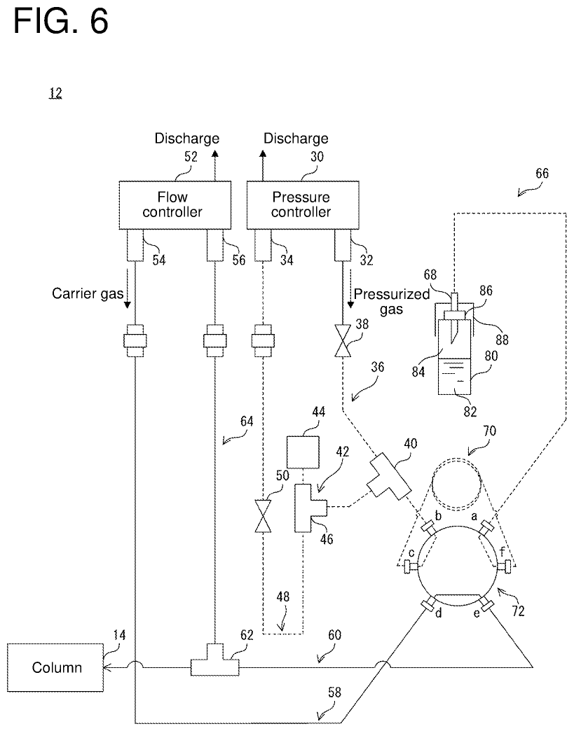

The sample derivation processing is processing for deriving the sample gas in the space 84 by the pressure in the space 84 in the sample container 80. When the sample derivation processing is started, the second open/close valve 50 is opened from the state shown in FIG. 4, and as shown in FIG. 6, the pressurized gas and the sample gas derived from the space 84 flows through the flow path. Note that the flow path through which the pressurized gas and the sample gas flow is represented by the broken line in FIG. 6.

The second open/close valve 50 is closed when a predetermined time has elapsed since it was opened. The sample derivation processing is terminated when the second open/close valve 50 is closed. Therefore, when the sample derivation processing ends, the sample supply device 12 becomes again in the state shown in FIG. 4, and the sample gas derived from the space 84 of the sample container 80 is captured by the sample loop 70.

Following the sample derivation processing, the sample supply processing is executed. The sample supply processing is the processing of supplying the sample gas in the sample loop 70 to the supply destination by supplying the carrier gas from the carrier gas supply unit 54 into the sample loop 70.

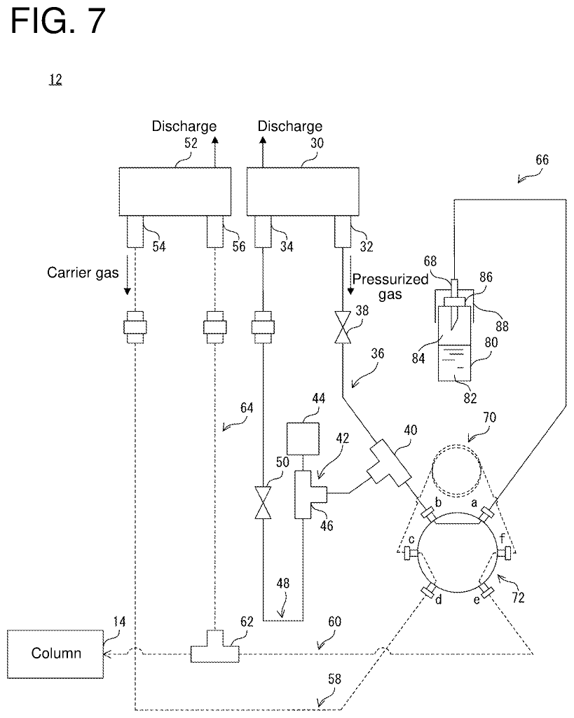

When the sample supply processing is started, the six-way valve 72 switches from the first state, i.e., the state shown in FIG. 4, to the second state, and some of the sample gas captured in the sample loop 70 is supplied to the supply destination along with the carrier gas by the carrier gas supplied from the carrier gas supply unit 54, as shown in FIG. 7. Note that the flow path through which the carrier gas and the sample gas flow is indicated by the broken line in FIG. 7.

The six-way valve 72 returns to the first state when the state is switched from the first state to the second state and a predetermined time has elapsed. The sample supply processing ends when the six-way valve 72 returns to the first state.

As described above, according to this embodiment, when it is determined that there is a possibility that the sample gas flows backward from the connection flow path to the pressurized gas supply unit 32 before the pressurization processing, it is possible to stop the execution of the pressurization processing or the like.

Further, in this embodiment, the first determination processing may be omitted, and instead, notification processing may be executed. However, the notification processing in such a case is the processing of notifying the pressure in the connection flow path based on a reference signal. Further, in this case, the chromatograph 10 or the operation reception unit 76 may accept an operation of stopping the execution of processing related to the supplying of the sample gas.

### 4. Concrete Example of Electrical Configuration of Sample Supply Device

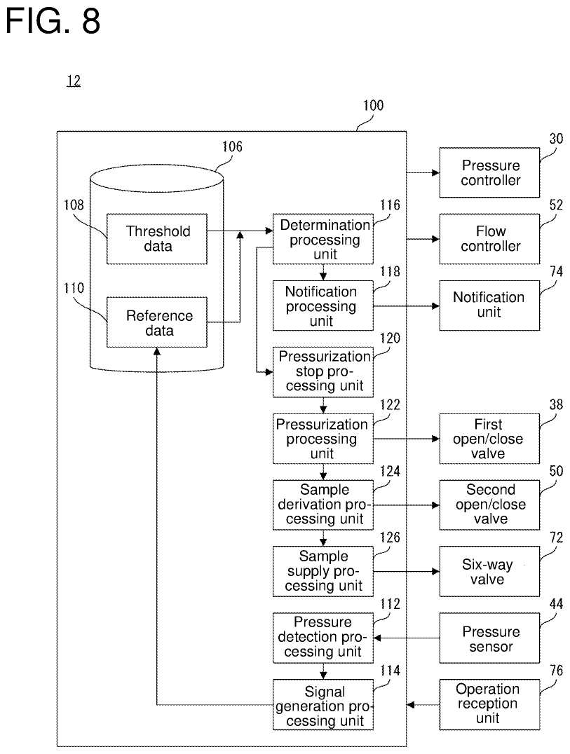

FIG. 8 is a functional block diagram showing a specific example of the electrical configuration of the sample supply device 12 according to this embodiment. In FIG. 8, the illustrations of the RAM 104 and the like are omitted.

The storage unit 106 stores threshold data 108, reference data 110, and the like. The threshold data 108 is data indicating the pressure value of a threshold. The threshold data 108 indicates, for example, a pressure value of a pressurized gas to be set in advance.

The reference data 110 is data corresponding to a reference signal. Therefore, the reference data 110 represents the detection result by the pressure sensor 44, i.e., the pressure value detected by the pressure sensor 44. Further, although not shown in the drawings, as described above, the storage unit 106 stores the control program, the executable data, and the like too.

The device controller 100 functions, by executing a control program by the CPU 102 (see FIG. 3), the pressure detection processing unit 112, the signal generation processing unit 114, the determination processing unit 116, the notification processing unit 118, the pressurization stop processing unit 120, the pressurization processing unit 122, the sample derivation processing unit 124, the sample supply processing unit 126, and the like.

The pressure detection processing unit 112 performs processing corresponding to the first pressure detection processing. The pressure detection processing unit 112 detects the pressure in the connection flow path based on the detection signal from the pressure sensor 44, in a state in which the first open/close valve 38 is closed and the insertion tube 68 is inserted into the space 84 in the sample container 80 before the processing by the pressurization processing unit 122.

The signal generation processing unit 114 generates a signal based on the detection result by the pressure detection processing unit 112. Note that this signal is stored in the storage unit 106 as reference data 110.

The determination processing unit 116 performs processing corresponding to the first determination processing. The determination processing unit 116 determines, based on the signal generated by the signal generation processing unit 114, whether there is a possibility that the sample gas flows backward from the connection flow path to the pressurized gas supply unit 32 when the first open/close valve 38 is opened by the pressurization processing unit 122.

Specifically, the determination processing unit 116 compares the pressure in the connection flow path detected by the pressure detection processing unit 112 with the threshold to determine whether there is a possibility that the sample gas flows backward. Note that at that time, the threshold data 108 and the reference data 110 are referred.

When it is determined that there is a possibility that the sample gas flows backward from the connection flow path to the pressurized gas supply unit 32 as a result of the determination by the determination processing unit 116, the notification processing unit 118 causes the notification unit 74 to notify the fact.

When it is determined that there is a possibility that the sample gas flows backward from the connection flow path to the pressurized gas supply unit 32 as a result of the determination processing unit 116, the pressurization stop processing unit 120 causes the pressurization processing unit 122 to stop the execution of the processing.

The pressurization processing unit 122 executes processing corresponding to pressurization processing. The pressurization processing unit 122 pressurizes the insertion tube 68 by opening the first open/close valve 38 and supplying the pressurized gas to the space 84 via the connection flow path and the insertion tube 68 in a state in which the insertion tube 68 is inserted in the space 84 in the sample container 80.

The sample derivation processing unit 124 executes the processing corresponding to the sample derivation processing. After executing the processing by the pressurization processing unit 122, the sample derivation processing unit 124 opens the second open/close valve 50 and causes the sample gas in the space 84 to be derived by the pressure in the space 84 of the sample container 80.

The sample supply processing unit 126 executes processing corresponding to the sample supply processing. The sample supply processing unit 126 switches the six-way valve 72 from the first state to the second state after the processing by the sample derivation processing unit 124 to supply the carrier gas from the carrier gas supply unit 54 to the sample loop 70, thereby supplying the sample gas in the sample loop 70 to the column 14 which is a sample derivation.

It should be noted that the notification processing unit 118 may be configured to notify the pressure in the connection flow path based on the signal generated by the signal generation processing unit 114, that is, the reference data 110. n this case, the determination processing unit 116 and the pressurization stop processing unit 120 are omitted. Flow

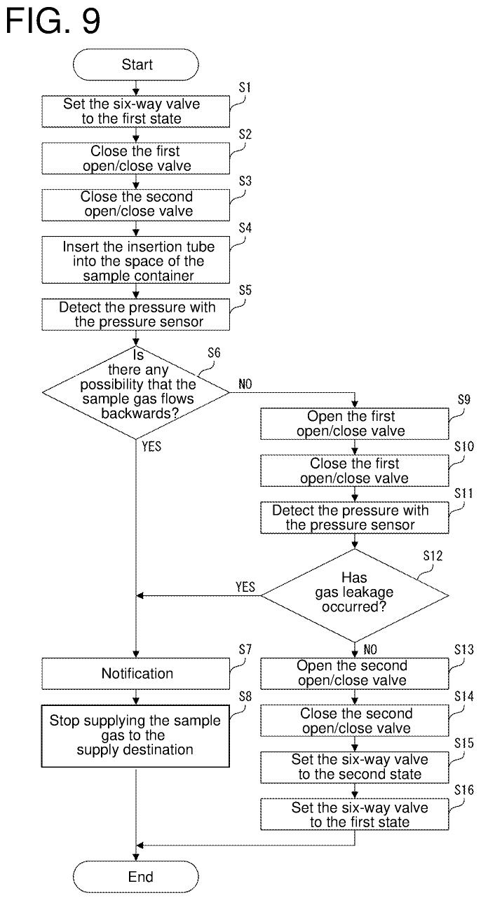

FIG. 9 is a flowchart showing an exemplary flow of operations of the sample supply device 12 according to this embodiment. In Step S1, the six-way valve 72 is set to the first state, and in Step S2, the first open/close valve 38 is closed. In Step S3, the second open/close valve 50 is closed, and in Step S4, the insertion tube 68 is inserted into the space 84 in the sample container 80. As a result, it becomes the state shown in FIG. 4.

In Step S5, the pressure sensor 44 detects the pressure in the connection flow path, specifically the pressure between the first open/close valve 38 and the insertion tube 68 in the flow path.

In Step S6, it is determined whether there is a possibility that the sample gas flows backward into the pressurized gas supply unit 32. Specifically, it is determined whether the pressure detected by the pressure sensor 44 is equal to or greater than the threshold.

In Step S6, if it is “NO,” that is, if there is no possibility that the sample gas flows backward to the pressurized gas supply unit 32, the processing proceeds to Step S9. On the other hand, in Step S6, if it is “YES,” that is, if there is a possibility that the sample gas flows backward, the processing proceeds to Step S7 to notify the fact.

In Step S8, supplying the sample gas to the supply destination is stopped. In Step S8, in particular, the remaining processing among processing related to supplying the sample gas is stopped.

In Step S9, as shown in FIG. 5, the pressurized gas is supplied by opening the first open/close valve 38. The first open/close valve 38 is closed in Step S10 after a predetermined time has elapsed since the first open/close valve 38 was opened. As a result, it becomes the state shown in FIG. 4 gains. In Step S11, the pressure is detected by the pressure sensor 44 as in Step S5.

In Step S12, it is determined whether a gas leakage has occurred. Specifically, it is determined whether the pressure in the connection flow path has changed by the threshold or more in the predetermined time.

In Step S12, if it is “NO,” that is, if no gas leakage has occurred, the processing proceeds to Step S13. On the other hand, in Step S12, if it is “YES,” that is, if a gas leakage has occurred, the processing proceeds to Step S7 to notify the fact.

In Step S13, as shown in FIG. 6, the second open/close valve 50 is opened to derive the sample gas from the sample container 80. When the predetermined time has elapsed after the opening of the second open/close valve 50, in Step S14, the second open/close valve 50 is closed to capture the sample gas with the sample loop 70. As a result, it become the state shown in FIG. 4 again.

In Step S15, as shown in FIG. 7, by setting the six-way valve 72 to the second state, the carrier gas supply unit 54 supplies the carrier gas to the sample loop 70 and supplies the sample gas captured by the sample loop 70 to the sample destination. In Step S16, the six-way valve 72 is made to the first state to terminate the carrier gas supply.

Note that the specific configuration described in this embodiment is merely an example, and can be appropriately changed according to an actual product. For example, the configuration of the flow path in the sample supply device 12 may be appropriately changed within a range in which the operations and effects of the present invention can be obtained. Further, in each step in the flowchart shown in this embodiment, the order of the processing can be changed as long as the same results can be obtained.

### 6. Aspects

It will be appreciated by those skilled in the art that the above-described exemplary embodiments are illustrative of the following aspects.

### (Item 1)

According to a first aspect of the present invention, a sample supply device for supplying a sample gas generated in a space in a sample container by volatilizing the sample in the sample container to a supply destination, includes:

an insertion tube configured to be inserted into the space in the sample container;

a pressurized gas supply unit connected to the insertion tube via a flow path to supply a pressurized gas for pressurizing the space to the space via the flow path and the insertion tube;

a valve configured to open and close the flow path;

a pressure sensor configured to detect a pressure between the valve and the insertion tube in the flow path; and

a controller to which a detection signal is input from the pressure sensor,

wherein the controller includes:

a pressurizing unit configured to pressurize the space by supplying the pressurized gas into the space from the pressurized gas supplying unit via the flow path and the insertion tube by opening the valve in a state in which the insertion tube is inserted into the space;

a sample derivation processing unit configured to derive the sample gas in the space by a pressure in the space before processing by the pressurization processing unit;

a pressure detection processing unit configured to detect a pressure in the flow path based on the detection signal from the pressure sensor in a state in which the valve is closed and the insertion tube is inserted into the space before processing by the pressurization processing unit; and

a signal generation processing unit configured to generate a signal based on a detection result by the pressure detection processing unit.

According to the sample supply device as recited in the above-described Item 1, it is possible to detect the pressure in the flow path, specifically between the valve in the flow path and the sample container before supplying the pressurized gas into the sample container by opening the valve provided in the flow path connecting the pressurized gas supply unit and the insertion tube in a state in which the insertion tube is inserted into the space in the sample container.

### (Item 2)

The sample supply device as recited in the above-described Item 1,

wherein the controller includes a determination processing unit for determining whether there is a possibility that the sample gas flows backward from the flow path to the pressurized gas supply unit when the valve is opened by the pressurization processing unit, based on the signal generated by the signal generation processing unit.

According to the sample supply device as recited in the above-described Item 2, it is possible to determine whether there is a possibility that the sample gas flows backward from the flow path to the pressurized gas supply unit before supplying the pressurized gas in the sample container by opening the valve.

### (Item 3)

In the sample supply device as recited in the above-described Item 1, it may configured such that processing by the determination processing unit includes processing of comparing the pressure in the flow path detected by the pressure detection processing unit with a threshold.

According to the sample supply device as recited in the above-described Item 3, it is possible to determine whether there is a possibility that the sample gas flows backward by comparing the pressure in the flow path and the threshold.

### (Item 4)

In the sample supply device as recited in the above-described Item 2, it may be configured such that the controller includes a pressurization stop processing unit configured to stop executing processing by the pressurization processing unit when it is determined that there is a possibility that the sample gas flows backward from the flow path to the pressurized gas supply unit as a result of a determination by the determination processing unit.

According to the sample supply device as recited in the above-described Item 4, when there is a possibility that the sample gas flows backward from the flow path to the pressurized gas supply unit, the pressurization processing is stopped, so that the closed state of the valve is maintained. In other words, in this case, the sample gas is prevented from flowing backward into the flow path, and consequently, contamination of the flow path by the sample gas is suppressed.

### (Item 5)

In the sample supply device as recited in the above-described Item 2, it may be configured such that the controller includes a notification processing unit configured to notify that there is a possibility that the sample gas flows backward from the flow path to the pressurized gas supply unit as a result of a determination by the determination processing unit.

According to the sample supply device as recited in the above-described Item 5, it is possible to notify that there is a possibility that the sample gas flows backward into the flow path.

### (Item 6)

In the sample supply device as recited in the above-described Item 1, it may be configured such that the controller includes a notification processing unit configured to notify the pressure in the flow path, based on the signal generated by the signal generation processing unit.

According to the sample supply device as recited in the above-described Item 6, it is possible to notify the pressure in the flow path before the supplying the pressurized gas into sample container by opening valve.

### (Item 7)

In the sample supply device as recited in the above-described Item 1, it may be configured such that the device further includes:

a sample loop configured to capture the sample gas derived from the space in accordance with processing by the sample derivation processing unit; and

a carrier gas supply unit configured to supply a carrier gas for supplying the sample gas in the sample loop to the supply destination,

wherein the controller includes

a sample supply processing unit configured to supply the sample gas in the sample loop to the supply destination by causing the carrier gas supply unit to supply the carrier gas into the sample loop after processing by the sample derivation processing unit.

According to the sample supply device as recited in the above-described Item 7, it is possible to detect the pressure in the flow path before supplying the pressurized gas by opening the valve and supply the sample gas captured by the carrier gas the supply destination after supplying the pressurized gas.

### (Item 8)

A gas chromatograph according to one aspect of the present invention includes:

the sample supply device as recited in claim 1; and

a column as a supply destination of a sample gas supplied from the sample supply device.

According to the gas chromatograph as recited in the above-described Item 8, it is possible to supply the sample gas to the column by the sample supply device capable of detecting the pressure in the flow path for supplying the pressurized gas into the sample container, before supplying the pressurized gas into the sample container

1. A sample supply device for supplying a sample gas generated in a space in a sample container by volatilizing the sample in the sample container to a supply destination, the sample supply device comprising:
an insertion tube configured to be inserted into the space in the sample container;
a pressurized gas supply unit connected to the insertion tube via a flow path to supply a pressurized gas for pressurizing the space to the space via the flow path and the insertion tube;
a valve configured to open and close the flow path;
a pressure sensor configured to detect a pressure between the valve and the insertion tube in the flow path; and
a controller to which a detection signal is input from the pressure sensor,
wherein the controller includes:
a pressurizing unit configured to pressurize the space by supplying the pressurized gas into the space from the pressurized gas supplying unit via the flow path and the insertion tube by opening the valve in a state in which the insertion tube is inserted into the space;
a sample derivation processing unit configured to derive the sample gas in the space by a pressure in the space before processing by the pressurization processing unit;
a pressure detection processing unit configured to detect a pressure in the flow path based on the detection signal from the pressure sensor in a state in which the valve is closed and the insertion tube is inserted into the space before processing by the pressurization processing unit; and
a signal generation processing unit configured to generate a signal based on a detection result by the pressure detection processing unit.

2. The sample supply device as recited in claim 1,
wherein the controller includes a determination processing unit for determining whether there is a possibility that the sample gas flows backward from the flow path to the pressurized gas supply unit when the valve is opened by the pressurization processing unit, based on the signal generated by the signal generation processing unit.

3. The sample supply device as recited in claim 2,
wherein processing by the determination processing unit includes processing of comparing the pressure in the flow path detected by the pressure detection processing unit with a threshold.

4. The sample supply device as recited in claim 2,
wherein the controller includes a pressurization stop processing unit configured to stop executing processing by the pressurization processing unit when it is determined that there is a possibility that the sample gas flows backward from the flow path to the pressurized gas supply unit as a result of a determination by the determination processing unit.

5. The sample supply device as recited in claim 2,
wherein the controller includes a notification processing unit configured to notify that there is a possibility that the sample gas flows backward from the flow path to the pressurized gas supply unit as a result of a determination by the determination processing unit.

6. The sample supply device as recited in claim 1,
wherein the controller includes a notification processing unit configured to notify the pressure in the flow path, based on the signal generated by the signal generation processing unit.

7. The sample supply device as recited in claim 1, further comprising:
a sample loop configured to capture the sample gas derived from the space in accordance with processing by the sample derivation processing unit; and
a carrier gas supply unit configured to supply a carrier gas for supplying the sample gas in the sample loop to the supply destination,
wherein the controller includes
a sample supply processing unit configured to supply the sample gas in the sample loop to the supply destination by causing the carrier gas supply unit to supply the carrier gas into the sample loop after processing by the sample derivation processing unit.

8. A gas chromatograph comprising:
the sample supply device as recited in claim 1; and
a column as a supply destination of a sample gas supplied from the sample supply device.
